(19) United States
(12) Patent Application Publication
(10) Pub. No.: US 2016/0374092 A1
(43) Pub. Date: Dec. 22, 2016

(54) TECHNIQUES FOR DETERMINING CHANNEL ALLOCATIONS

(71) Applicants: Jie GAO, Sunnyvale, CA (US); Krishnan RAJAMANI, San Diego, CA (US); Xintian LIN, Mountain View, CA (US); Ulun KARACAOGLU, San Diego, CA (US)

(72) Inventors: Jie GAO, Sunnyvale, CA (US); Krishnan RAJAMANI, San Diego, CA (US); Xintian LIN, Mountain View, CA (US); Ulun KARACAOGLU, San Diego, CA (US)

(73) Assignee: INTEL CORPORATION, Santa Clara, CA (US)

(21) Appl. No.: 15/120,999

(22) PCT Filed: Mar. 5, 2014
(86) PCT No.: PCT/US2014/020494

§ 371 Date: Aug. 23, 2016

(51) Int. Cl. H04W 72/04

(52) U.S. Cl. CPC H04W 72/0486; H04W 84/12

(57) ABSTRACT

Various embodiments are generally directed to an apparatus and method for determining a first channel occupancy for a first channel and a second channel occupancy for a second channel, determining a first channel allocation for the first channel based on the first channel occupancy and the second channel occupancy and determining a second channel allocation for the second channel based on first channel occupancy and the second channel occupancy. In addition, various embodiments may include communicating first information on the first channel based on the first channel allocation and second information on the second channel based on the second channel allocation.

### TECHNICAL FIELD

Embodiments described herein generally relate to determining channel allocations for one or more channels.

### BACKGROUND

Wireless communication has rapidly evolved over the past decades. Today's wireless devices provide many different types of functionality and capabilities and may communicate information with many different devices using various protocols. Further, as consumers demand more and more capabilities from their wireless devices, they expect these capabilities to be provided cheaply and in a device that has a small form factor. Thus, device manufacturers are under constant pressure to reduce costs and create smaller and smaller devices. In some instances, device manufactures may design wireless devices to share resources in an effort to meet these constraints.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 illustrates an exemplary embodiment of a first computing system.

FIG. 2 illustrates an embodiment of a first computing device.

FIG. 3 illustrates a first logical flow diagram for determining channel allocations.

FIGS. 4A/4B illustrate embodiments of channel allocation timing diagrams.

FIG. 5 illustrates an embodiment of a second logical flow diagram for determining channel allocations.

FIG. 6 illustrates an embodiment of a first computing architecture.

FIG. 7 illustrates an embodiment of a second computing device.

### DETAILED DESCRIPTION

As previously discussed, wireless device resources may be shared among one or more applications operating on the wireless device. For example, a wireless device may include a transceiver component and one or more applications may share the transceiver component to communicate information with other devices. Thus, various embodiments are generally directed to techniques for determining channel allocations to communicate information via the transceiver component. In embodiments, a channel allocation may be channel allocation percentage of a total duty cycle used to determine a time period, such as a dwell time period in which information is communicated on a particular channel. The time period may be a portion of a total duty cycle and communication of information may be allocated a dwell time period of a particular length. For example, information may be communicated over a channel during a channel allocation or dwell time period.

In some embodiments, the transceiver component may communicate first information, such as wireless local area network (WLAN) information, on a channel in a frequency band with a device and may communicate second information, such as peer-to-peer screencasting information, on a channel in a frequency band with the same or another device. In some embodiments, the transceiver component may operate in single channel mode (SCM) and the WLAN information and the peer-to-peer screencasting information may be communicated on the same channel in the same frequency band, such as the 2.4 Ghz frequency band. However, a user's experience may be degraded due to congestion on the same channel. Thus, some embodiments are directed to a transceiver component operating in a dual channel mode (DCM). For example, the WLAN information may be communicated on a channel in the 2.4 Ghz frequency band using one or more IEEE 802.11 protocols according to IEEE 802.11-2012 Revision of IEEE Standard 802.11-2007, Mar. 29, 2012. Further, the peer-to-peer screencasting information may be communicated on a channel in the 5 Ghz frequency band using a Miracast® protocol as specified by the WiFi alliance. The embodiments are not limited to the number, type or arrangement of channels, bands, etc. described herein for purposes of illustration.

Typically, a transceiver component may allocate channel allocations, such as 20/80 or 40/60, for a first and second channel to split time. This channel allocation scheme is generally fixed and irrespective of the information communicated on either the WLAN channel or the Miracast® channel. However, there may be instances when little or no information is being communicated on one of the channels and the other channel is be utilized at full or near full capacity level. Therefore, various embodiments are also generally directed to determining and adaptively adjusting channel allocations for channels to ensure that the transceiver component is being utilized in an efficient manner. More specifically, the channels may be monitored and sampled to determine channel occupancy or occupancy percentages for the channels based on the current channel allocations. As will be discussed in more detail below, the channel allocations may be adaptively adjusted based on the channel occupancy for the channels and the current channel allocations. These and other details will become more apparent with the following description with reference to the figures.

With general reference to notations and nomenclature used herein, the detailed description that follows may be presented in terms of program procedures executed on a computer or network of computers. These procedural descriptions and representations are used by those skilled in the art to most effectively convey the substance of their work to others skilled in the art.

A procedure is here and is generally conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein that form part of one or more embodiments. Rather, the operations are machine operations. Useful machines for performing operations of various embodiments include general-purpose digital computers or similar devices.

Various embodiments also relate to apparatus or systems for performing these operations. This apparatus may be specially constructed for the required purpose or it may comprise a general-purpose computer as selectively activated or reconfigured by a computer program stored in the computer. The procedures presented herein are not inherently related to a particular computer or other apparatus. Various general-purpose machines may be used with programs written in accordance with the teachings herein, or it may prove convenient to construct more specialized apparatus to perform the required method steps. The required structure for a variety of these machines will appear from the description given.

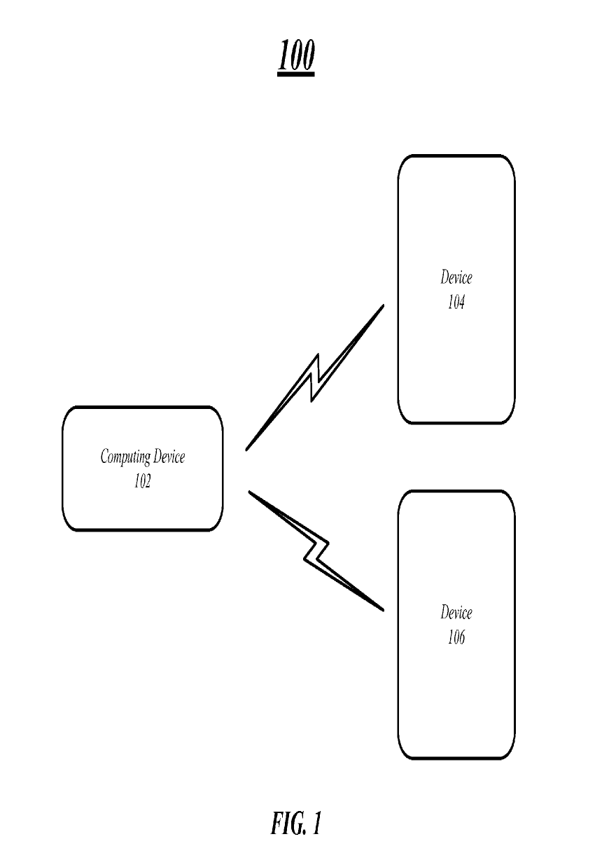

FIG. 1 illustrates a general overview of a computing system 100 for communicating information between devices. More specifically, FIG. 1 illustrates computing device 102 communicating information with devices 104 and 106. In various embodiments, the computing device 102 may be any type of computing device, such as a personal digital assistant, a mobile computing device, a smart phone, a cellular telephone, a handset, a one-way pager, a two-way pager, a messaging device, a computer, a laptop computer, a notebook computer, a handheld computer, a tablet computer, a network appliance, a web appliance, multiprocessor systems, processor-based systems, or any combination thereof. The embodiments are not limited in this context.

Device 104 may be any computing device such as a wireless access point, a base station, a network component, a computer, a laptop computer, or any other computing device. In various embodiments, computing device 102 may communicate WLAN information with the device 104 according to one or more IEEE 802.11 standards for wireless local area networks (WLANs), such as IEEE 802.11-2012 Revision of IEEE Standard 802.11-2007, Mar. 29, 2012. In various embodiments, the WLAN information may include any type of information communicated over an access point or base station. For example, the WLAN information may include video information, audio information, HyperText Markup Language (HTML) information, webpage information, Internet information, multimedia information, television information and so forth.

In some embodiments, device 106 may be a peer-to-peer screencast embedded or wireless display compatible display device including a Liquid Crystal Display (LCD), a Thin Film Transistor-LCD (TFT-LCD), an Organic Light Emitting Diode (OLED), a flexible display, a three-dimensional (3D) display, a projector, a television, computer monitor, or combination thereof. Computing device 102 may communicate peer-to-peer screencasting information according to one or more peer-to-peer screencasting protocols such as Miracast® with device 106. The peer-to-peer screencasting information may be any information that may be displayed on a display, such as display information, video information, graphical user interface information, screen information, television information, multimedia information and so forth. The embodiments are not limited in this context.

Computing device 102 may communicate with devices 104 and 106 in a single channel mode or a dual channel mode. However, communicating using a single channel mode may degrade a user's experience during concurrent operations due to congestion on the single channel in a particular frequency band. Thus, various embodiments are directed to the computing device 102 communicating with devices 104 and 106 using a dual channel mode. More specifically, computing device 102 may communicate with device 104 on a first channel in a first frequency band and may communicate with device 106 on a second channel in a second frequency band. For example, the computing device 102 may communicate information with device 104 on a first channel of the 2.4 Ghz frequency band using any one of 802.11 protocols and with device 106 in a second channel in a second frequency band, such as the 5 Ghz frequency band utilizing any peer-to-peer screencasting protocol. In some embodiments, the first and second frequency band may be the same frequency band and the first and second channel may be in the same frequency band. Various embodiments are not limited in this manner.

In addition, computing device 102 may include a single transceiver to communicate with devices 104 and 106. Therefore, channel allocations may be determined and adjusted for the transceiver to communicate on the first channel with device 104 and on the second channel with device 106. More specifically, the transceiver of computing device 102 may communicate information with device 104 in a time period based on the first channel allocation and may communicate information with device 106 in a time period based on the second channel allocation. Various details will become more apparent with the following description.

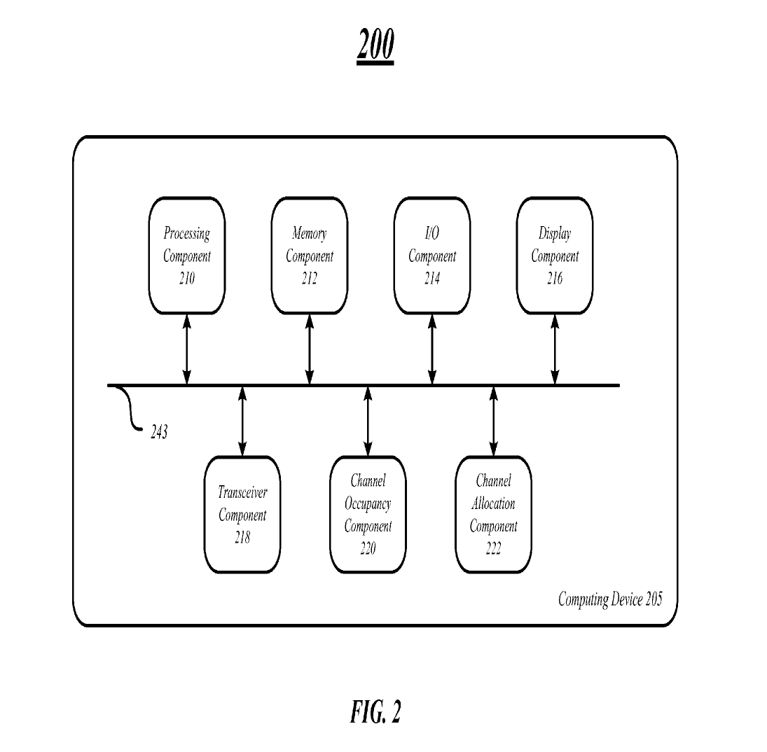

FIG. 2 illustrates an exemplary embodiment of a system 200 and computing device 205 including components to process information and enable communication between other devices via one or more wired or wireless connections. In various embodiments, computing device 205 may be the same or similar as computing device 102 illustrated in FIG. 1. FIG. 2 illustrates computing device 205 having a processing component 210, a memory component 212, an I/O component 214, a display component 216, a transceiver component 218, a channel occupancy component 220 and a channel allocation component 222. The components of computing device 205 may communicate with each other via one or more interconnects, buses, traces, control lines, data lines and so forth such as interconnect 243. Further, FIG. 2 illustrates computing device 205 having a specific number of components, however, various embodiments are not limited in this manner. Computing device 205 may include any number of components for communicating and processing information.

In various embodiments, computing device 205 may include a processing component 210. Processing component 210 may be one or more of any type of computational element, such as but not limited to, processing circuitry including a microprocessor, a processor, central processing unit, digital signal processing unit, dual core processor, mobile device processor, desktop processor, single core processor, a system-on-chip (SoC) device, complex instruction set computing (CISC) microprocessor, a reduced instruction set (RISC) microprocessor, a very long instruction word (VLIW) microprocessor, or any other type of processor or processing circuit on a single chip or integrated circuit. The processing component 210 may be connected to and communicate with the other elements and components of the computing system via an interconnect 243, such as one or more buses, control lines, and data lines.

Computing device 205 may also include a memory component 212 to couple to processing component 210. In various embodiments, the memory component 212 may store data and information for system 200. For example, the memory component 212 may store and maintain information such as current channel allocation information, instructions to determine channel occupancy percentages for one or more channels and determine new channel allocations for channels. Various embodiments are not limited in this manner and memory component 212 may store and maintain any information for processing.

Memory component 212 may be coupled to processing component 210 via interconnect 243, or by a dedicated communications bus between processing component 210 and memory component 212, as desired for a given implementation. Memory component 212 may be implemented using any machine-readable or computer-readable media capable of storing data, including both volatile and non-volatile memory. In some embodiments, the machine-readable or computer-readable medium may include a non-transitory medium. The embodiments are not limited in this context.

The memory component 212 can store instructions and data momentarily, temporarily, or permanently. The memory component 212 may also store temporary variables or other intermediate information while the processing component 210 is executing instructions. The memory component 212 is not limited to storing the above discussed data and may store any type of data.

The computing device 205 may include an input/output (I/O) component 214 having at least one of an input device or sensor, such as one or more buttons, a keyboard, a keypad, a touchscreen display, a touch sensitive device, a microphone, a biometric finger printer reader, biometric eye scanner or any other device used for inputting information into computing device 205. Moreover, the I/O component 214 may be a sensor including any hardware or logic to detect one or more touches or inputs on or near a housing of the apparatus, a display of the apparatus including a touchscreen display or touch sensitive display. The one or more inputs may occur separately, simultaneously and/or sequentially. The I/O component 214 monitors touches that occur on the housing or display and produces signals indicative thereof. In addition, the I/O component 214 may be used to input any information or data into the computing device 205.

In various embodiments, the I/O component 214 may include one or more components to output information to a user. For example, the I/O component 214 may include a speaker to output an audible noise or a haptic feedback device to output a vibration. The I/O component 214 may be located anywhere within or on computing device 205, or may be separate and connected to the computing device 205 via a wired or wireless connection.

In embodiments, the computing device 205 may include a display component 216. Display component 216 may constitute any display device capable of displaying information received from processing component 210 or a graphics processing unit. The display component 216 may include at least one of a Liquid Crystal Display (LCD), a Thin Film Transistor-LCD (TFT-LCD), an Organic Light Emitting Diode (OLED), a flexible display, a three-dimensional (3D) display, touchscreen and/or touch sensitive display and a projector, for example. The display component 216 may display a User interface (UI) or a Graphical User Interface (GUI) associated with controlling functionality of the computing device 205. The computer device may include two or more display units, according to various embodiments. The display component 216 may display any information or data associated computing system 205.

The computing device 205 may also include a transceiver component 218 including one or more components and circuitry to transmit and receive information using radio-frequency signals. More specifically, the transceiver may include circuitry to produce radio-frequency mobile radio signals which are to be sent and for processing radio-frequency mobile radio signals which have been received. To this end, the transceiver component 218 may be coupled to one or more antenna (not shown). The transmitted or received mobile radio signals are in one or more particular frequency ranges, which are typically prescribed by the mobile radio standard(s) supported by the radio-frequency assemblies. For example, transceiver component 218 may include circuitry to process information according to one or more IEEE 802.11 standards for wireless local area networks (WLANs), such as IEEE 802.11-2012 Revision of IEEE Standard 802.11-2007, Mar. 29, 2012 and one or more peer-to-peer screencasting protocols such as Miracast®. Various embodiments are not limited in this manner and transceiver component 218 may transmit or receive information via any standard in any frequency range with one more devices.

In some embodiments, the transceiver component 218 may operate in a single channel mode or dual channel mode. In single channel mode, the transceiver component 218 may utilize a single channel to communicate information to one or more devices. For example, the transceiver component 218 may communicate information to a device using one or more of the IEEE 802.11 standards using a particular channel. The transceiver component 218 may communicate information to the same device or a different device using the Miracast® standard on the same particular channel. However, communicating using a single channel mode may degrade a user's experience during concurrent operations due to congestion on the single channel in a particular frequency band.

In some embodiments, the transceiver component 218 may communicate using a dual channel mode. The transceiver component 218 may communicate with a first device on a first channel in a first frequency band and may communicate with the same or a different device on a second channel in a second frequency band. In some embodiments, the first and second frequency bands may be the same frequency band and the channels may be different within the same frequency band. By way of example, the transceiver component may communicate information with a device on a first channel of the 2.4 Ghz frequency band using any of the 802.11 protocols and another device in a second channel in a second frequency band, such as the 5 Ghz frequency band utilizing the Miracast protocol. Various embodiments are not limited in this manner and any information may be communicated using any frequency band and protocol.

Computing device 205 may also include a channel occupancy component 220 to determine channel occupancy for each of one or more channels. The channel occupancy may be an occupancy percentage a channel is in use during a time period, such as a dwell time period. In some embodiments, the channel occupancy component 220 may determine the occupancy percentage for each of the one or more channels while the channels are in use. For example, the channel occupancy component 220 may determine that a particular channel is being used 50% of the time during a dwell time period.

The dwell time period for a channel may be the time period in which the transceiver is allocated to spend communicating over the channel. As will be discussed in more detail below, each channel used for communication may be assigned or allotted a channel allocation for the transceiver to communicate information over that particular channel. The time period in which each channel is allotted time to communicate is the channel allocation and the dwell time period.

To determine the occupancy percentage the channel occupancy component 220 may sample a channel on a periodic basis during the dwell time period. The occupancy percentage may be based on the number of times use is detected divided by the total number of times the channel was sampled. In some embodiments, the channel occupancy component 220 may sample the channel on a periodic basis such as every second, millisecond, microsecond, and so forth to determine whether a channel is in use or not in use. Various embodiments are not limited in this manner and the channel may be sampled on a non-period basis to determine the channel occupancy.

While sampling a channel, the channel occupancy component 220 may determine that the channel is in use based one or more sampling criteria being met. The one or more sampling criteria may include a determination as to whether detected energy on the channel is above a clear channel assessment threshold. For example, the channel occupancy component 220 may determine if the detected energy is greater than a clear channel assessment threshold of −62 dbm when determining whether the channel is in use or not in use.

The one more sampling criteria may also include determining whether received packets are valid. More specifically, the channel occupancy component 220 may determine if the received packet is valid based on the communication protocol assigned to use the particular channel. For example, if the channel is used to send and receive 802.11 packets, the channel occupancy component 220 may determine if the received packet is a valid 802.11 packet In some embodiments, the one or more sampling criteria may include determining whether a packet is being sent over the channel while sampling the channel. For example, the channel occupancy component 220 may sample a channel and determine if the transceiver component 218 is sending a packet over the channel during the time the channel is being sampled.

In another example, the one or more sampling criteria may include determining whether a network allocation vector (NAV) for the channel is non-zero to determine whether the channel is in use or not in use. More specifically, a non-zero value for the NAV for the particular channel indicates that the channel is in use. On the other hand, if the NAV is zero the channel is not in use.

In some embodiments, the channel occupancy component 220 may store a channel busy counter in memory, such as memory component 212 to use when determining the channel occupancy percentage for each of the channels. The initial value for the channel busy counter for each of the channels may be set to zero and may be incremented by one each time one or more of the above-discussed sampling criteria is met indicating the channel is in use. The channel occupancy component 220 may divide the channel busy counter value by a total counter value to determine the channel occupancy percentage, as illustrated by equation 1.

OP=busy_counter/total_counter, (1)
OP=the channel occupancy percentage for the sampled channel,
busy_counter=the busy channel counter for the sampled channel, and
total_counter=the total number of times the channel was sampled during a dwell time period.

By way of example, the channel dwell time may be 60 milliseconds and the channel occupancy component 220 may sample the channel every one microsecond to determine if the channel is in use. The busy_counter may be incremented by one every time the one or more criteria are met. For example, the channel occupancy component 220 may detect channel activity based on the one or more sampling criteria 40,000 times when sampling the channel during the channel dwell time. Thus, in this example the channel occupancy percentage equals 40,000/60,000 or ˜66.6%. Various embodiments are not limited to the above discussed example, the channel occupancy component 220 may determine the channel occupancy percentage for a channel based on any channel dwell time and detected activity.

Moreover, the channel occupancy component 220 may determine the channel occupancy percentage for each one or more channels in use by the transceiver component 218. For example and as previously discussed, the transceiver may be operating in dual channel mode where a first channel is allocated for the computing device 205 to communicate with a device via the 802.11 protocol and a second channel is allocated for the computing device to communicate with the same or a different device via the Miracast protocol. In this example, the channel occupancy component 220 may determine the channel occupancy percentage for both the first and second channel.

In some embodiments, the channel occupancy component 220 may also determine the channel occupancy percentage of a channel based on the traffic volume on the channel and the total available bandwidth for a transceiver. For example, the channel occupancy component 220 may determine traffic volume for incoming and outgoing packets. The total number of bytes received and transmitted on the first channel and the physical bandwidth on the first channel determine the channel occupancy on the first channel. The total number of bytes received and transmitted on the second channel and the physical bandwidth on the second channel determine the channel occupancy on the second channel. In these embodiments, the channel occupancy component 220 may use the dwell time period to measure the traffic volume on the channel or a time sliding window average algorithm to provide an averaged traffic volume for the channel.

In various embodiments, the channel occupancy component 220 may be implemented in hardware, software or combination thereof. For example, the channel occupancy component 220 may be hardware logic or logic stored in memory to calculate the channel occupancy percentage for channels used by the transceiver component 218 and computing device 205. Further and as will be discussed in more detail below, the channel occupancy percentage may be used to determine and adjust channel allocations for each channel used to communicate information over.

In some embodiments, the computing device 205 may also include a channel allocation component 222 to determine and adaptively adjust channel allocations for communicating information using one or more channels via transceiver component 218. The channel allocation component 222 may determine channel allocations based on channel occupancy percentages and the current channel allocations for each of channels the transceiver component 218 may communicate information over. A channel allocation for a channel may be channel allocation percentage of a total duty cycle used to determine a time period, such as a dwell time period, for information to be communicated by the transceiver component 218. For example, first information may be communicated during a first channel allocation or dwell time period and second information may be communicate during a second channel allocation or dwell time period.

Various embodiments may include communicating WLAN information over a first channel based on a first channel allocation using one or more IEEE 802.11 protocols and peer-to-peer screencasting information over a second channel based on a second channel allocation using a Miracast protocol. The channel allocation component 222 may determine and adaptively adjust the channel allocations for the first channel and second channel. More specifically, the channel allocation component 222 may determine a channel allocation percentage of a total duty cycle time for each of the channels to communicate information using the transceiver component 218 to determine the channel allocations.

The channel allocation percentage may be the percentage of the total duty cycle time the transceiver spends on a particular channel. For example, the total duty cycle time may equal 120 milliseconds and the first channel may be allocated 40% of the total duty cycle time and the second channel may be allocated 60% of the total duty cycle time. Thus, the first channel may have a channel allocation or a dwell time period of 48 milliseconds or 40% of the 120 milliseconds and the second channel may have a channel allocation or a dwell time period of 72 milliseconds or 60% of the 120 milliseconds. The dwell time period for each of the channels is the amount of the time transceiver spends transceiving information on that particular channel associated with the dwell time period. Various embodiments are not limited to the above-recited example and the total duty cycle time may be any time period and the channel allocation percentages may be any percentage of the total duty cycle time.

The channel allocation component 222 may adaptively adjust the channel allocations and channel allocation percentages based on channel occupancy percentages determined by the channel occupancy component 220 on a continuous, periodic, or non-periodic basis. Moreover, when determining channel allocation percentages for two channels utilized for communication, equation 2 may be used to determine a first channel allocation and equation 3 may be used to determine a second channel allocation.

P₁_{_}New=(OP₁*P₁_{_}Current)/(OP₁*P₁_{_}Current+OP₂*P₂_{_}Current), (2)

P₂_{_}New=(OP₂*P₂_{_}Current)/(OP₁*P₁_{_}Current+OP₂*P₂_{_}Current), wherein (3)
P₁_{_}New=the new channel allocation percentage for a first channel,
P₂_{_}New=the new channel allocation percentage for a second channel,
OP₁=the determined channel occupancy percentage for a first channel,
P₁_{_}Current=the current channel allocation percentage for the first channel,
OP₂=the determined channel occupancy percentage for a second channel, and
P₂_{_}Current=the current channel allocation percentage for the second channel.

In one or more embodiments, a channel allocation may be determined for an nth channel based on equation 4.

Pₙ_{_}New=(OPₙ*Pₙ_{_}Current)/(OP₁*P₁_{_}Current+OP₂*P₂_{_}Current . . . +OPₙ*Pₙ_{_}Current), wherein (4)
Pₙ_{_}New=the new channel allocation percentage for the nth channel,
OPₙ=the determined channel occupancy percentage for the nth channel,
Pₙ_{_}Current=the current channel allocation for the nth channel,
OP₁=the determined channel occupancy percentage for a first channel,
P₁_{_}Current=the current channel allocation for the first channel,
OP₂=the determined channel occupancy percentage for a second channel,
P₂_{_}Current=the current channel allocation for the second channel,
OPₙ=the channel occupancy percentage for nth channel, and
Pₙ_{_}Current=the current channel allocation for the nth channel.

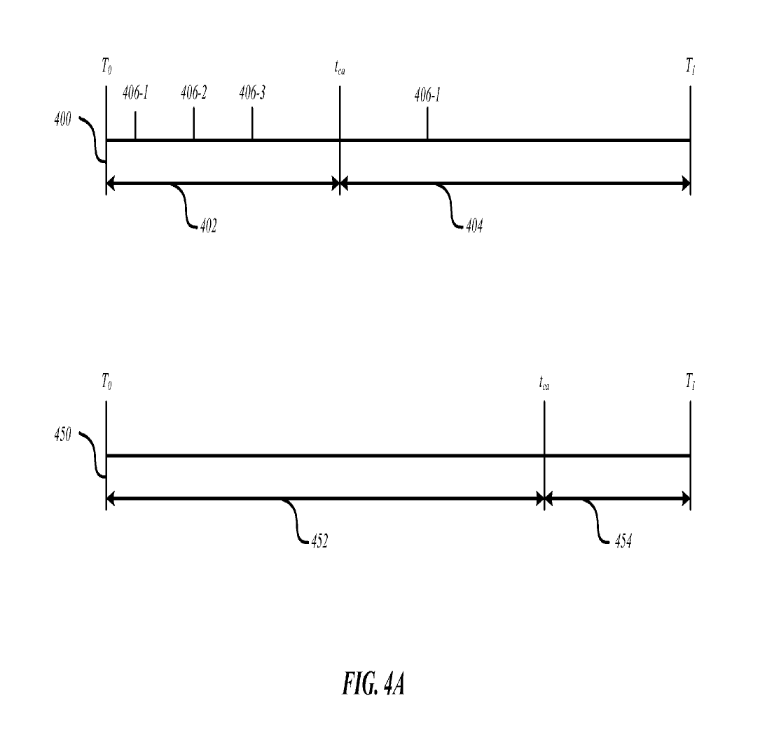

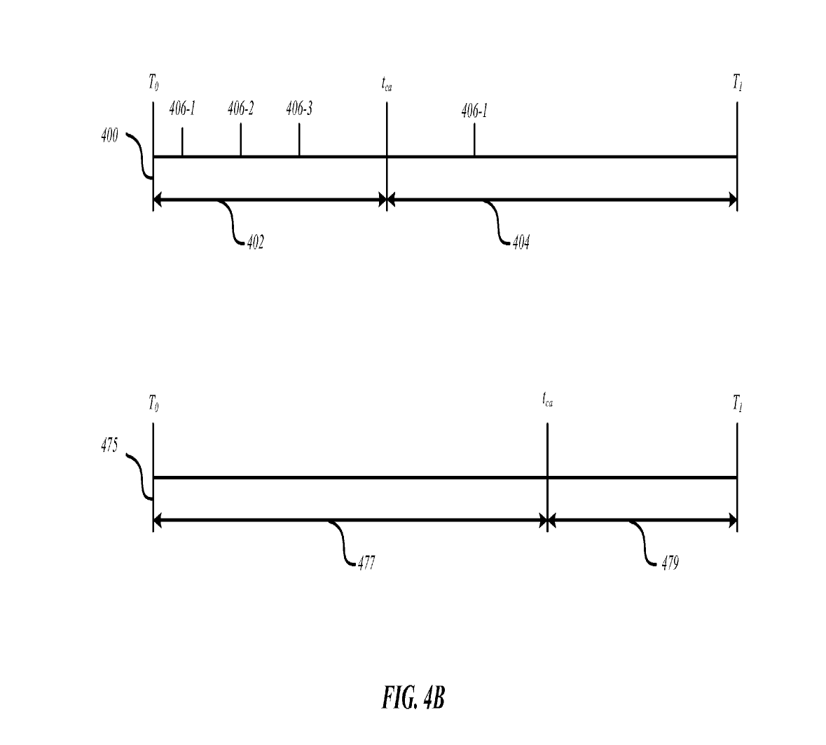

The channel occupancy component 220 may determine the channel occupancy for each of the channels 1, 2, . . . n, as previously discussed. Further, the channel allocation component 222 may determine the current channel allocations for each of the channel based on previously determined channel allocations or default channel allocations for each of the channels, 1, 2, . . . n. In various embodiments, the current channel allocations may be stored in a memory, such as memory component 212 and the channel allocation component 222 may retrieve or read the current channel allocations from the memory. Further details for determining and adaptively adjusting channel allocations will be illustrated by way of example in FIGS. 4A and 4B.

In some embodiments, the channel allocation component 222 may determine the channel allocations for channels based on a quality of service requirement for traffic communicated on the one or more channels. The quality of service requirement may include an availability requirement requiring that communication over a channel is available a particular amount of time, a bandwidth requirement that requires a specific bandwidth for communication over a channel, a latency requirement to reduce excess delay or throughput limitations, an error rate requirement to limit an amount of errors during communication over a channel, and so forth.

For example, WLAN information may be communicated on a first channel via one or more IEEE 802.11 protocols and peer-to-peer screencasting information may be communicated on a second channel via the Miracast protocol. In this example, the peer-to-peer screencasting information may require more bandwidth than what would be allocated to the second channel based on equations 2 and 3 to communicate information to another device. However, various embodiments are not limited in this manner and in another example, the WLAN information may require additional bandwidth.

Equations 5 and 6 illustrate an application of a bias factor value based on a quality of service required for information communicated on a second channel. Various embodiments are not limited in this manner and as previously discussed the bias factor value may be applied to the first channel.

P₁_{_}New=(OP₁*P₁_{_}Current)/(OP₁*P₁_{_}Current+α*OP₂*P₂_{_}Current), (5)

P₂_{_}New=(α*OP₂*P₂_{_}Current)/(OP₁*P₁_{_}Current+α*OP₂*P₂_{_}Current), (6)

wherein
P₁_{_}New=the new channel allocation percentage for a first channel,
P₂_{_}New=the new channel allocation percentage for a second channel,
OP₁=the determined channel occupancy percentage for a first channel,
P₁_{_}Current=the current channel allocation percentage for the first channel,
α=a bias factor value,
OP₂=the determined channel occupancy percentage for a second channel, and
P₂_{_}Current=the current channel allocation percentage for the second channel.
   In an example, the peer-to-peer screencasting information may include streaming video information and additional bandwidth may be required so that the user experience is not degraded. In particular, a bias factor value may be set to a value of 1.5 causing the channel allocation for the second channel to be greater than if no bias factor value is applied. The bias factor value can be any value greater than zero. In various embodiments, a bias factor value greater than one causes the channel having the bias factor value applied to it to have additional channel allocation. Further, a bias factor value less than one causes the channel having the bias factor value applied to it to have less channel allocation.

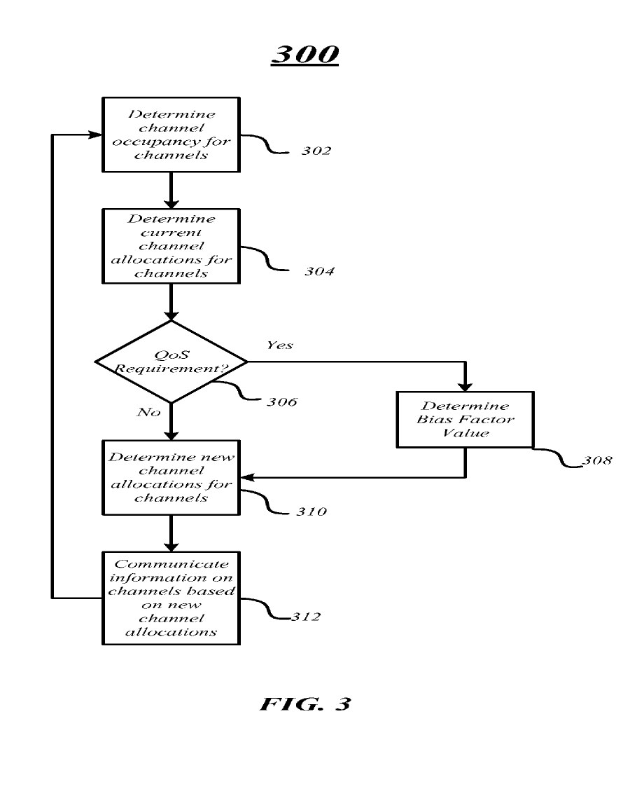

FIG. 3 illustrates a first logic flow diagram 300 for determining and adjusting channel allocations for one or more wireless channels. At block 302 the channel occupancy for one or more channels may be determined. More specifically, an occupancy percentage for each of the one or more channels may be determined while the channels are in use during a dwell time period. Each channel may have a dwell time period which may be a fraction or percentage of a total duty cycle time period. The dwell time period is the period of time in which the transceiver may communicate over a channel and the occupancy percentage is the percentage of time in which the transceiver is actually communicating information over the channel during the dwell time period.

In some embodiments, the channel may be sampled on a periodic or non-periodic basis to determine whether the channel in use or not in use. The channel may be considered in use during a sampling when the one more sampling criteria are met including determining whether received packets are valid, determining whether a packet is being sent during the sampling of the channel, determining whether a network allocation vector (NAV) for the channel is non-zero and detected energy on the channel is above a clear channel assessment threshold.

In some embodiments, the channel occupancy percentage may be determined based on the traffic volume on the channel and the total available bandwidth for a transceiver. For example, the traffic volume for incoming and outgoing packets may be monitored during the dwell time period. The total number of bytes received and transmitted on the first channel and the physical bandwidth on the first channel determine the channel occupancy on first channel. The total number of bytes received and transmitted on the second channel and the physical bandwidth on the second channel determine the channel occupancy on second channel.

At block 304, the logic flow 300 may include determining the current channel allocations for each of one or more channels. The current channel allocations may be a percentage of a total duty cycle time for each of the channels. In various embodiments, the current channel allocations may be stored in a memory, such as memory component 212 and they may be retrieved or read from the memory. The current channel allocations may be default values or values based on a previous channel allocation determination.

In some embodiments, a determination as to whether one or more of the channels has a quality of service requirement may be made at decision block 306. The quality of service requirement may include an availability requirement, a bandwidth requirement, a latency requirement, an error rate requirement, and so forth.

If at decision block 306, a quality of service requirement is required for a channel, a bias factor value may be determined at block 308. The bias factor value may be based on the quality of service requirement. For example, the bias factor value may be set to ensure that that a specific bandwidth amount is achieved based on a bandwidth requirement. In another example, the bias factor value may be set to ensure that an availability requirement is met for a channel. Various embodiments are not limited to these examples and the bias factor value may be set based on any of the quality of service requirements to ensure that they are met.

At block 310, the channel allocation for one or more channels may be determined. The channel allocation may be based on the occupancy percentage(s) determined at block 302, the current channel allocation(s) determined at block 304 and any bias factor values required for one or more channels. The channel allocation may be a channel allocation percentage of a total duty cycle time for a transceiver. For example, a first channel allocation percentage may be determined for a first channel and a second channel allocation may be determined for second channel. The first and second channel allocation percentages may be used to determine a first dwell time period for the first channel and a second dwell time period for the second channel. The first and second dwell time periods may be based on the channel allocation percentages and the total duty cycle time period for the transceiver.

In various embodiments, one or more wireless communications may be sent over one or more channels based on the channel allocations at block 312. More specifically, a transceiver may communicate information switching between the channels based on the channel allocations determined at block 310. In some embodiments, a transceiver may communicate first information over a first channel based a first channel allocation and communicate second information over a second channel based on a second channel allocation. For example, the first information may be WLAN information and the transceiver may communicate the WLAN information over the first channel via one or more IEEE 802.11 protocols during a first dwell time period. The second information may be peer-to-peer screencasting information and the transceiver may communicate the peer-to-peer screencasting information via the Mircast protocol during a second dwell time period.

In various embodiments, logic flow 300 may be repeated on a periodic basis to determine channel allocations for one or more channels. For example, new channel allocations may be determined on a per second, tens of seconds, minute, and so forth basis. In the same or other embodiments, logic flow 300 may be repeated on a non-periodic basis such as each time one or more applications request a channel to communicate information over.

FIG. 4A illustrates exemplary embodiments of channel allocation timing diagrams 400 and 450. Channel allocation timing diagrams 400 and 450 illustrate a first channel allocation for a first channel and a second channel allocation for second channel. For example, channel allocation timing diagram 400 illustrates a total duty cycle time period having a time period of length T₁, a first dwell time period 402 for a transceiver to communicate over a first channel and a second dwell time period 404 for the transceiver to communicate over a second channel. The first dwell time period 402 and the second dwell time period 404 may each have a length based on channel allocations for the first and second channels. The first dwell time period 402 length may be the time from T₀ to t_{ca} and the second dwell time period 404 length may be the time from t_{ca} to T₁. Time t_{ca} may be determined from the total duty cycle period and the channel allocations.

In channel allocation timing diagram 400, the first dwell time period 402 and the second dwell time period 404 may be based on default channel allocation values. By way of example, the channel allocation percentage may be 40% for the first channel and the channel allocation percentage for the second channel may be 60% for second channel. In this example, if the total duty cycle time period is 10 milliseconds (ms), then time t_{ca} is 4 ms, the first channel dwell time is 4 ms and the second channel dwell time is 6 ms.

Further, channel allocation timing diagram 400 illustrates an example of sampling the first and second channels while in the first and second dwell time periods, 402 and 404. In this exemplary embodiment, while sampling the first channel during the first dwell time period 402 three sampling criteria were detected 406-1, 406-2 and 406-3. Further, while sampling the second channel during the second dwell time period 404 one sampling criterion 406-4 was detected.

As previously discussed, the channel occupancy can be determined based on the sampling criteria events occurring and the sampling. Continuing with example discussed above, assuming that the total duty cycle period is 10 milliseconds, the first dwell time period 402 is 4 ms, the second dwell time period 404 is 6 ms and the channels are being sampled on a per millisecond basis, the first channel occupancy for the first channel is ¾ or 75% and the second channel occupancy for the second channel is ⅙ or ˜16.6% based on equation 1.

Channel allocation timing diagram 450 illustrates an exemplary embodiment of adjusted or new channel allocations for first and second channels based on channel occupancy percentages for the first channel and second channel discussed above with respect to channel allocation timing diagram 400. The new channel allocations for the first and second channel may be determined based on the first channel occupancy of 75%, the second channel occupancy of 25%, the first current channel allocation of 4 ms and a second current channel allocation of 6 ms. More specifically, equation 2 may be used to determine that the new channel allocation for the first channel is ˜75% and equation 3 may be used to determine that the new channel allocation for the second channel is ˜25%. Therefore in this example with a total duty cycle time period of 10 ms, t_{ca} may be 7.5 milliseconds, the first dwell time period 452 may be 7.5 milliseconds and the second dwell time period 454 may be 2.5 milliseconds.

FIG. 4B illustrates channel allocation timing diagrams 400 and 475. Channel allocation timing diagram 400 illustrated in FIG. 4B is the same as channel allocation timing diagram 400 illustrated in FIG. 4A. More specifically, channel allocation time diagram 400 illustrates a total duty cycle time period having a time period of length T₁, a first dwell time period 402 for a transceiver to communicate over a first channel and a second dwell time period 404 for the transceiver to communicate over a second channel. The first dwell time period 402 and the second dwell time period 404 may each have a length based on channel allocations for the first and second channels. The first dwell time period 402 length may be the time from T₀ to t_{ca} and the second dwell time period 404 length may be the time from t_{ca} to T₁. Time tₑₐ may be determined from the total duty cycle period and the channel allocations.

However, channel allocation timing diagram 475 illustrates a timing diagram having new channel allocations when the second channel has a quality of service channel requirement. Continuing with example discussed above, assuming that the total duty cycle period is 10 milliseconds, the first dwell time period 402 is 4 ms, the second dwell time period 404 is 6 ms and the channels are being sampled on a per millisecond basis, the first channel occupancy for the first channel is ¾ or 75% and the second channel occupancy for the second channel is ⅙ or ˜16.6% based on equation 1. In addition, the second channel may have a quality of service requirement with a bias factor value of 1.5.

In this exemplary embodiment, a new channel allocation for the first channel may be ˜66.6% based on equation 5 and a new channel allocation for the second channel may be ˜33.3% based on equation 6. Moreover, the first dwell time period 477 may be ˜6.6 ms, the second dwell time period 479 may be 3.3 ms and t_{ca} may be ˜6.6 ms. As illustrated by channel timing diagrams 450 and 475, a bias factor value of 1.5 changes the channel allocations, such that the channel allocation for the second channel is increased from ˜25% to ˜33% and the channel allocation for the first channel is decreased from ˜75% to ˜66%.

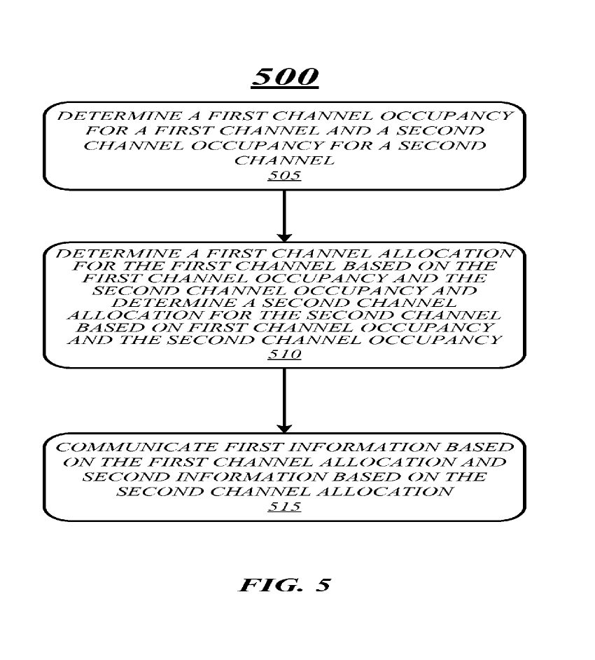

FIG. 5 illustrates an exemplary embodiment of logic flow 500. The logic flow 500 may be representative of some or all of the operations executed by one or more embodiments described herein. For example, the logic flow 500 may illustrate operations performed by the system 100 and computing device 205.

In the illustrated embodiment shown in FIG. 5, the logic flow 500 may include determining a first channel occupancy for a first channel and a second channel occupancy for a second channel at block 505. The channel occupancy for the first channel and the second channel may be an occupancy percentage of the channel in use during an allocated period of time for each of the channels. More specifically, the first channel may be sampled during a first dwell time period to determine an occupancy percentage of use of the first channel and the second channel may be sampled during a second dwell time period to determine an occupancy percentage of use of the second channel. Each of the channels may be determined to be in use during a sampling when one or more sampling criteria are met, as previously discussed above.

In some embodiments, the logic flow 500 may also include determining a first channel allocation for the first channel based on the first channel occupancy and the second channel occupancy and determine a second channel allocation for the second channel based on the first occupancy and the second channel occupancy at block 510. More specifically, a new channel allocation percentage or dwell time period based on the percentage may be determined for the first and second channels based on the occupancy percentages for the first and second channels determined at block 505, the current channel allocation for the first channel and the current channel allocation for the second channel.

As previously discussed, a new channel allocation or percentage for each of the channels may be determined such that the channels are allocated in an efficient manner. For example, if the first channel is not using a significant amount of its current channel allocation, such as less than 50%, and the second channel is using most of its current channel allocation, such as greater than 80%, new channel allocations may be determined to shorten the dwell time period for the first channel and lengthen the dwell time period for the second channel. Various embodiments are not limited in this manner and channel allocations may be adjusted or determined on a dynamic basis based on equations 1 through 6, as previously discussed.

Logic flow 500 may also include communicating first information based on the first channel allocation and second information based on the second channel allocation at block 515. For example, the first information may be WLAN information communicated on a channel in the 2.4 Ghz frequency band via one or more of a 802.11 protocol. The second information may be peer-to-peer screencasting information communicated on a channel in the 5 Ghz frequency band via the Miracast protocol. Various embodiments are not limited in this manner.

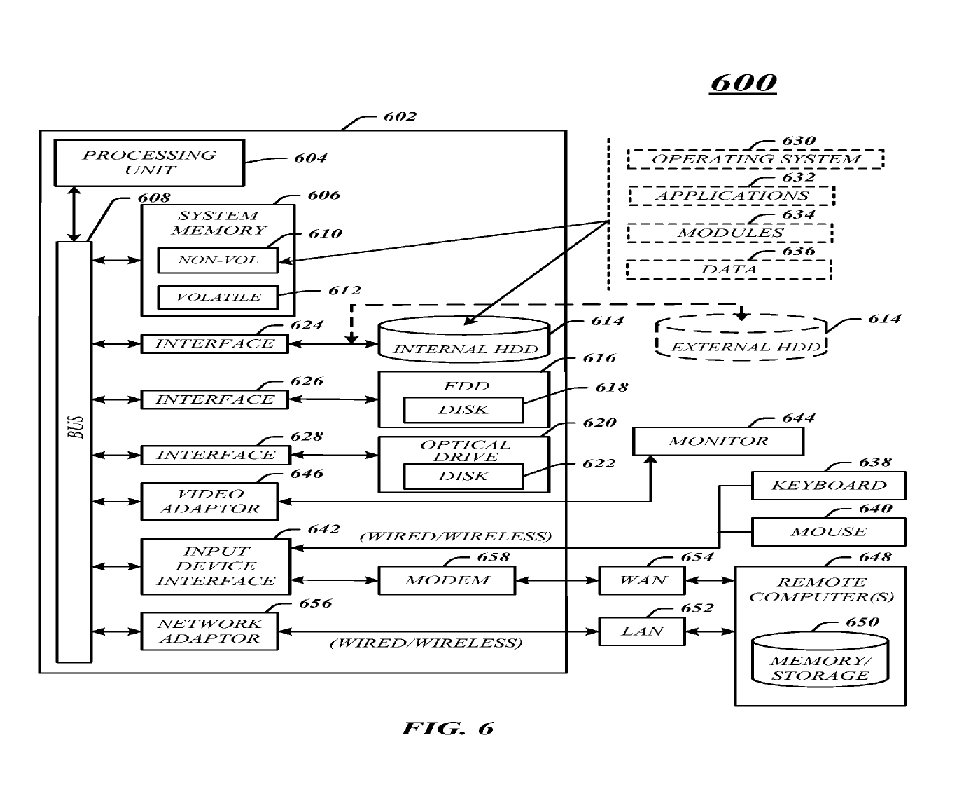

FIG. 6 illustrates an embodiment of an exemplary computing architecture 600 suitable for implementing various embodiments as previously described. In one embodiment, the computing architecture 600 may comprise or be implemented as part of computing system 100 and computing device 205.

As used in this application, the terms “system” and “component” are intended to refer to a computer-related entity, either hardware, a combination of hardware and software, software, or software in execution, examples of which are provided by the exemplary computing architecture 600. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 600 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 600.

As shown in FIG. 6, the computing architecture 600 comprises a processing unit 604, a system memory 606 and a system bus 608. The processing unit 604 can be any of various commercially available processors, such as those described with reference to computing device 205 shown in FIG. 2.

The system bus 608 provides an interface for system components including, but not limited to, the system memory 606 to the processing unit 604. The system bus 608 can be any of several types of bus structure that may further interconnect to a memory bus (with or without a memory controller), a peripheral bus, and a local bus using any of a variety of commercially available bus architectures. Interface adapters may connect to the system bus 608 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 600 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 606 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 6, the system memory 606 can include non-volatile memory 610 and/or volatile memory 612. A basic input/output system (BIOS) can be stored in the non-volatile memory 610.

The computer 602 may include various types of computer-readable storage media in the form of one or more lower speed memory units, including an internal (or external) hard disk drive (HDD) 614, a magnetic floppy disk drive (FDD) 616 to read from or write to a removable magnetic disk 618, and an optical disk drive 620 to read from or write to a removable optical disk 622 (e.g., a CD-ROM or DVD). The HDD 614, FDD 616 and optical disk drive 620 can be connected to the system bus 608 by a HDD interface 624, an FDD interface 626 and an optical drive interface 628, respectively. The HDD interface 624 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 610, 612, including an operating system 630, one or more application programs 632, other program modules 634, and program data 636. In one embodiment, the one or more application programs 632, other program modules 634, and program data 636 can include, for example, the various applications and/or components of the device 102 and device 205.

A user can enter commands and information into the computer 602 through one or more wire/wireless input devices, for example, a keyboard 638 and a pointing device, such as a mouse 640. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 604 through an input device interface 642 that is coupled to the system bus 608, but can be connected by other interfaces such as a parallel port, IEEE 1394 serial port, a game port, a USB port, an IR interface, and so forth.

A monitor 644 or other type of display device is also connected to the system bus 608 via an interface, such as a video adaptor 646. The monitor 644 may be internal or external to the computer 602. In addition to the monitor 644, a computer typically includes other peripheral output devices, such as speakers, printers, and so forth.

The computer 602 may operate in a networked environment using logical connections via wire and/or wireless communications to one or more remote computers, such as a remote computer 648. The remote computer 648 can be a workstation, a server computer, a router, a personal computer, portable computer, microprocessor-based entertainment appliance, a peer device or other common network node, and typically includes many or all of the elements described relative to the computer 602, although, for purposes of brevity, only a memory/storage device 650 is illustrated. The logical connections depicted include wire/wireless connectivity to a local area network (LAN) 652 and/or larger networks, for example, a wide area network (WAN) 654. Such LAN and WAN networking environments are commonplace in offices and companies, and facilitate enterprise-wide computer networks, such as intranets, all of which may connect to a global communications network, for example, the Internet.

When used in a LAN networking environment, the computer 602 is connected to the LAN 652 through a wire and/or wireless communication network interface or adaptor 656. The adaptor 656 can facilitate wire and/or wireless communications to the LAN 652, which may also include a wireless access point disposed thereon for communicating with the wireless functionality of the adaptor 656.

When used in a WAN networking environment, the computer 602 can include a modem 658, or is connected to a communications server on the WAN 654, or has other means for establishing communications over the WAN 654, such as by way of the Internet. The modem 658, which can be internal or external and a wire and/or wireless device, connects to the system bus 608 via the input device interface 642. In a networked environment, program modules depicted relative to the computer 602, or portions thereof, can be stored in the remote memory/storage device 650. It will be appreciated that the network connections shown are exemplary and other means of establishing a communications link between the computers can be used.

The computer 602 is operable to communicate with wire and wireless devices or entities using the IEEE 802 family of standards, such as wireless devices operatively disposed in wireless communication (e.g., IEEE 802.11 over-the-air modulation techniques). This includes at least WiFi (or Wireless Fidelity), WiMax, and Bluetooth™ wireless technologies, 3G, 4G, LTE wireless technologies, among others. Thus, the communication can be a predefined structure as with a conventional network or simply an ad hoc communication between at least two devices. WiFi networks use radio technologies called IEEE 802.11x (a, b, g, n, etc.) to provide secure, reliable, fast wireless connectivity. A WiFi network can be used to connect computers to each other, to the Internet, and to wire networks (which use IEEE 802.3-related media and functions).

The various elements of the computer system 100 as previously described with reference to FIGS. 1-5 may comprise various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

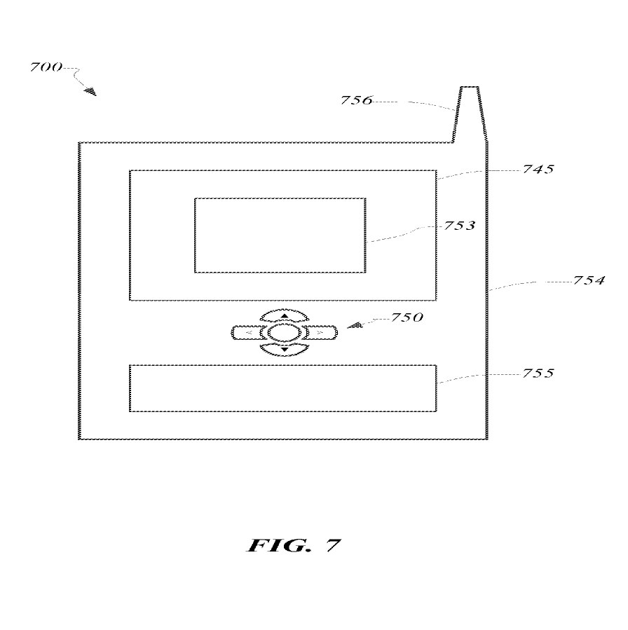

FIG. 7 illustrates embodiments of a small form factor device 700. In embodiments, for example, device 700 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 7, device 700 may include a display 745, a navigation controller 750, a user interface 754, a housing 755, an I/O device 756, and an antenna 757. Display 745 may include any suitable display unit for displaying information appropriate for a mobile computing device, and may be the same as or similar to display component 216 of FIG. 2. Navigation controller 750 may include one or more navigation features which may be used to interact with user interface 754. I/O device 756 may include any suitable I/O device for entering information into a mobile computing device. Examples for I/O device 756 may include an alphanumeric keyboard, a numeric keypad, a touch pad, input keys, buttons, switches, rocker switches, microphones, speakers, voice recognition device and software, and so forth. Information also may be entered into device 700 by way of microphone. Such information may be digitized by a voice recognition device. The embodiments are not limited in this context.

The detailed disclosure now turns to providing examples that pertain to further embodiments. Examples one through twenty-nine (1-29) provided below are intended to be exemplary and non-limiting.

In a first example, a computing device or apparatus may include circuitry, a transceiver coupled with the circuitry. The apparatus may also include a channel occupancy component for execution on the circuitry to determine a first channel occupancy for a first channel and a second channel occupancy for a second channel and a channel allocation component for execution on the circuitry to determine a first channel allocation for the first channel based on the first channel occupancy and the second channel occupancy and determine a second channel allocation for the second channel based on the first occupancy and the second channel occupancy. Further, the transceiver may communicate first information on the first channel based on the first channel allocation and communicate second information on the second channel based on the second channel allocation.

In a second example and in furtherance of the first example, the computing device or apparatus may include the channel occupancy component to periodically sample the first channel to determine the first channel occupancy and to periodically sample the second channel to determine the second channel occupancy.

In a third example and in furtherance of any of the previous examples, the computing device or the apparatus may include the channel occupancy component to periodically sample the first channel on a per microsecond basis during a first dwell time period for the first channel and to periodically sample the second channel on a per microsecond basis during a second dwell time period for the second channel.

In a fourth example and in furtherance of any of the previous examples, the computing device or the apparatus may include the channel occupancy component to determine the first channel occupancy when sampling the first channel or the second channel occupancy when sampling the second channel based on one or more of measured energy above a clear channel assessment (CCA) threshold, a received packet is valid, and a network allocation vector (NAV) is non-zero.

In a fifth example and in furtherance of any of the previous examples, the computing device or the apparatus may include the channel occupancy component to determine the first channel occupancy for the first channel based on traffic volume on the first channel and available bandwidth for the transceiver and to determine the second channel occupancy for the second channel based on traffic volume on the second channel and available bandwidth for the transceiver.

In a sixth example and in furtherance of any of the previous examples, the computing device or the apparatus may include the channel allocation component to determine the first channel allocation and the second channel allocation based on a quality of service requirement for the first channel or the second channel, the quality of service requirement comprising one or more of an availability requirement, a bandwidth requirement, a latency requirement, and an error rate requirement.

In a seventh example and in furtherance of any of the previous examples, the transceiver to communicate the first information comprising wireless local area network (WLAN) information on the first channel and to communicate the second information comprising peer-to-peer wireless screencasting information on the second channel.

In an eighth example and in furtherance of any of the previous examples, the computing device or the apparatus may include a memory, a display device and at least one input device. Further, the memory, the display device and the at least one input device may be coupled with the circuitry.

In a ninth example and in furtherance of any of the previous example, at least one computer-readable storage medium comprising a plurality of instructions that when executed enable processing circuitry to determine a first channel occupancy for a first channel and a second channel occupancy for a second channel, determine a first channel allocation for the first channel based on the first channel occupancy and the second channel occupancy, determine a second channel allocation for the second channel based on first channel occupancy and the second channel occupancy and communicate first information on the first channel based on the first channel allocation and second information on the second channel based on the second channel allocation.

In a tenth example and in furtherance of any of the previous example, at least one computer-readable storage medium comprising a plurality of instructions that when executed enable processing circuitry to periodically sample the first channel to determine the first channel occupancy and to periodically sample the second channel to determine the second channel occupancy.

In an eleventh example and in furtherance of any of the previous example, at least one computer-readable storage medium comprising a plurality of instructions that when executed enable processing circuitry to periodically sample the first channel on a per microsecond basis during a first dwell time period for the first channel and to periodically sample the second channel on a per microsecond basis during a second dwell time period for the second channel.

In a twelfth example and in furtherance of any of the previous example, at least one computer-readable storage medium comprising a plurality of instructions that when executed enable processing circuitry to determine the first channel occupancy when sampling the first channel or the second channel occupancy when sampling the second channel based on one or more of measured energy above a clear channel assessment (CCA) threshold, a received packet is valid, and a network allocation vector (NAV) is non-zero.

In a thirteenth example and in furtherance of any of the previous example, at least one computer-readable storage medium comprising a plurality of instructions that when executed enable processing circuitry to determine the first channel occupancy for the first channel based on traffic volume on the first channel and available bandwidth for the transceiver and to determine the second channel occupancy for the second channel based on traffic volume on the second channel and available bandwidth for the transceiver.

In a fourteenth example and in furtherance of any of the previous example, at least one computer-readable storage medium comprising a plurality of instructions that when executed enable processing circuitry to determine the first channel allocation and the second channel allocation based on a quality of service requirement for the first channel or the second channel, the quality of service requirement comprising one or more of an availability requirement, a bandwidth requirement, a latency requirement, and an error rate requirement.

In a fifteenth example and in furtherance of any of the previous example, at least one computer-readable storage medium comprising a plurality of instructions that when executed enable processing circuitry to communicate the first information comprising wireless local area network (WLAN) information on the first channel and to communicate second information comprising peer-to-peer wireless screencasting information on the second channel.

In a sixteenth example and in furtherance of any of the previous example, a computer-implemented method may include determining a first channel occupancy for a first channel and a second channel occupancy for a second channel, determining a first channel allocation for the first channel based on the first channel occupancy and the second channel occupancy, determining a second channel allocation for the second channel based on the first channel occupancy and the second channel occupancy and communicating first information on the first channel based on the first channel allocation and second information on the second channel based on the second channel allocation.

In a seventeenth example and in furtherance of any of the previous example, a computer-implemented method may include periodically sampling the first channel to determine the first channel occupancy and periodically sampling the second channel to determine the second channel occupancy.

In an eighteenth example and in furtherance of any of the previous example, a computer-implemented method may include periodically sampling the first channel on a per microsecond basis during a first dwell time period for the first channel and periodically sampling the second channel on a per microsecond basis during a second dwell time period for the second channel.

In a nineteenth example and in furtherance of any of the previous example, a computer-implemented method may include determining the first channel occupancy when sampling the first channel or the second channel occupancy when sampling the second channel based on one or more of measured energy above a clear channel assessment (CCA) threshold, a received packet is valid, and a network allocation vector (NAV) is non-zero.

In a twentieth example and in furtherance of any of the previous example, a computer-implemented method may include determining the first channel occupancy for the first channel based on traffic volume on the first channel and available bandwidth for the transceiver and determining the second channel occupancy for the second channel based on traffic volume on the second channel and available bandwidth for the transceiver.

In a twenty-first example and in furtherance of any of the previous example, a computer-implemented method may include determining the first channel allocation and the second channel allocation based on a quality of service requirement for the first channel or the second channel, the quality of service requirement comprising one or more of an availability requirement, a bandwidth requirement, a latency requirement, and an error rate requirement.

In a twenty-second example and in furtherance of any of the previous example, a computer-implemented method may include communicating the first information comprising wireless local area network (WLAN) information on the first channel and communicating second information comprising peer-to-peer wireless screencasting information on the second channel. In a twenty-third example and in furtherance of any of the previous example an apparatus may include means for determining a first channel occupancy for a first channel and a second channel occupancy for a second channel, means for determining a first channel allocation for the first channel based on the first channel occupancy and the second channel occupancy, means for determining a second channel allocation for the second channel based on first channel occupancy and the second channel occupancy and means for communicating first information on the first channel based on the first channel allocation and second information on the second channel based on the second channel allocation.

In a twenty-fourth example and in furtherance of any of the previous example, an apparatus may include means for periodically sampling the first channel to determine the first channel occupancy and means for periodically sampling the second channel to determine the second channel occupancy.

In a twenty-fifth example and in furtherance of any of the previous example, an apparatus may include means for periodically sampling the first channel on a per microsecond basis during a first dwell time period for the first channel and means for periodically sampling the second channel on a per microsecond basis during a second dwell time period for the second channel.

In a twenty-sixth example and in furtherance of any of the previous example, an apparatus may include means for determining the first channel occupancy when sampling the first channel or the second channel occupancy when sampling the second channel based on one or more of measured energy above a clear channel assessment (CCA) threshold, a received packet is valid, and a network allocation vector (NAV) is non-zero.

In a twenty-seventh example and in furtherance of any of the previous example, an apparatus may include means for determining the first channel occupancy for the first channel based on traffic volume on the first channel and available bandwidth for the transceiver and means for determining the second channel occupancy for the second channel based on traffic volume on the second channel and available bandwidth for the transceiver.

In a twenty-eighth example and in furtherance of any of the previous example, an apparatus may include means for determining the first channel allocation and the second channel allocation based on a quality of service requirement for the first channel or the second channel, the quality of service requirement comprising one or more of an availability requirement, a bandwidth requirement, a latency requirement, and an error rate requirement.

In a twenty-ninth example and in furtherance of any of the previous example, an apparatus may include means for communicating the first information comprising wireless local area network (WLAN) information on the first channel and means for communicating second information comprising peer-to-peer wireless screencasting information on the second channel.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. An apparatus, comprising:
circuitry;
a transceiver coupled with the circuitry;
a channel occupancy component to be executed on the circuitry to determine a first channel occupancy for a first channel and a second channel occupancy for a second channel; and
a channel allocation component to be executed on the circuitry to determine a first channel allocation for the first channel based on the first channel occupancy and the second channel occupancy and determine a second channel allocation for the second channel based on the first occupancy and the second channel occupancy,
the transceiver to communicate first information on the first channel based on the first channel allocation and communicate second information on the second channel based on the second channel allocation.

2. The apparatus of claim 1, the channel occupancy component to periodically sample the first channel to determine the first channel occupancy and to periodically sample the second channel to determine the second channel occupancy.

3. The apparatus of claim 2, the channel occupancy component to periodically sample the first channel on a per microsecond basis during a first dwell time period for the first channel and to periodically sample the second channel on a per microsecond basis during a second dwell time period for the second channel.

4. The apparatus of claim 2, the channel occupancy component to determine the first channel occupancy when sampling the first channel or the second channel occupancy when sampling the second channel based on one or more of measured energy above a clear channel assessment (CCA) threshold, a received packet is valid, and a network allocation vector (NAV) is non-zero.

5. The apparatus of claim 1, the channel occupancy component to determine the first channel occupancy for the first channel based on traffic volume on the first channel and available bandwidth for the transceiver and to determine the second channel occupancy for the second channel based on traffic volume on the second channel and available bandwidth for the transceiver.

6. The apparatus of claim 1, the channel allocation component to determine the first channel allocation and the second channel allocation based on a quality of service requirement for the first channel or the second channel, the quality of service requirement comprising one or more of an availability requirement, a bandwidth requirement, a latency requirement, and an error rate requirement.

7. The apparatus of claim 1, the transceiver to communicate the first information comprising wireless local area network (WLAN) information on the first channel and to communicate the second information comprising peer-to-peer wireless screencasting information on the second channel.

8. The apparatus of claim 1, comprising:
a memory;
a display device; and
at least one input device, and
the memory, the display device and the at least one input device coupled with the circuitry.

9. At least one computer-readable storage medium comprising a plurality of instructions that when executed enable processing circuitry to:
determine a first channel occupancy for a first channel and a second channel occupancy for a second channel;
determine a first channel allocation for the first channel based on the first channel occupancy and the second channel occupancy;
determine a second channel allocation for the second channel based on first channel occupancy and the second channel occupancy; and
communicate first information on the first channel based on the first channel allocation and second information on the second channel based on the second channel allocation.

10. The at least one computer-readable storage medium of claim 9 comprising the plurality of instructions that when executed enable processing circuitry to:
periodically sample the first channel to determine the first channel occupancy; and
periodically sample the second channel to determine the second channel occupancy.

11. The at least one computer-readable storage medium of claim 10 comprising the plurality of instructions that when executed enable processing circuitry to:
periodically sample the first channel on a per microsecond basis during a first dwell time period for the first channel; and
periodically sample the second channel on a per microsecond basis during a second dwell time period for the second channel.

12. The at least one computer-readable storage medium of claim 10 comprising the plurality of instructions that when executed enable processing circuitry to determine the first channel occupancy when sampling the first channel or the second channel occupancy when sampling the second channel based on one or more of measured energy above a clear channel assessment (CCA) threshold, a received packet is valid, and a network allocation vector (NAV) is non-zero.

13. The at least one computer-readable storage medium of claim 9 comprising the plurality of instructions that when executed enable processing circuitry to:
determine the first channel occupancy for the first channel based on traffic volume on the first channel and available bandwidth for the transceiver; and
determine the second channel occupancy for the second channel based on traffic volume on the second channel and available bandwidth for the transceiver.

14. The at least one computer-readable storage medium of claim 9 comprising the plurality of instructions that when executed enable processing circuitry to determine the first channel allocation and the second channel allocation based on a quality of service requirement for the first channel or the second channel, the quality of service requirement comprising one or more of an availability requirement, a bandwidth requirement, a latency requirement, and an error rate requirement.

15. The at least one computer-readable storage medium of claim 9 comprising the plurality of instructions that when executed enable processing circuitry to:
communicate the first information comprising wireless local area network (WLAN) information on the first channel; and
communicate second information comprising peer-to-peer wireless screencasting information on the second channel.

16. A computer-implemented method, comprising:
determining a first channel occupancy for a first channel and a second channel occupancy for a second channel;
determining a first channel allocation for the first channel based on the first channel occupancy and the second channel occupancy;
determining a second channel allocation for the second channel based on the first channel occupancy and the second channel occupancy; and
communicating first information on the first channel based on the first channel allocation and second information on the second channel based on the second channel allocation.

17. The computer-implemented method of claim 16, comprising:
periodically sampling the first channel to determine the first channel occupancy; and
periodically sampling the second channel to determine the second channel occupancy.

18. The computer-implemented method of claim 17, comprising:
periodically sampling the first channel on a per microsecond basis during a first dwell time period for the first channel; and
periodically sampling the second channel on a per microsecond basis during a second dwell time period for the second channel.

19. The computer-implemented method of claim 17, comprising:
determining the first channel occupancy when sampling the first channel or the second channel occupancy when sampling the second channel based on one or more of measured energy above a clear channel assessment (CCA) threshold, a received packet is valid, and a network allocation vector (NAV) is non-zero.

20. The computer-implemented method of claim 16, comprising:
determining the first channel occupancy for the first channel based on traffic volume on the first channel and available bandwidth for the transceiver; and
determining the second channel occupancy for the second channel based on traffic volume on the second channel and available bandwidth for the transceiver.

21. The computer-implemented method of claim 16, comprising:
determining the first channel allocation and the second channel allocation based on a quality of service requirement for the first channel or the second channel, the quality of service requirement comprising one or more of an availability requirement, a bandwidth requirement, a latency requirement, and an error rate requirement.

22. The computer-implemented method of claim 16, comprising:
communicating the first information comprising wireless local area network (WLAN) information on the first channel; and
communicating second information comprising peer-to-peer wireless screencasting information on the second channel.
